(19) United States
(12) Patent Application Publication
(10) Pub. No.: US 2012/0105760 A1
(43) Pub. Date: May 3, 2012

(54) LIQUID CRYSTAL DISPLAY DEVICE

(75) Inventors: Yoshio TORIYAMA, Nagara (JP); Tetsuya Enomoto, Togane (JP)

(73) Assignees: Panasonic Liquid Crystal Display Co., Ltd.; Hitachi Displays, Ltd.

(21) Appl. No.: 13/282,646

(22) Filed: Oct. 27, 2011

(30) Foreign Application Priority Data
Oct. 29, 2010 (JP) 2010-242940

(51) Int. Cl. G02F 1/13357

(52) U.S. Cl. 349/58

(57) ABSTRACT

A liquid crystal display device is provided, where dust can be prevented from entering into the display device and the quality of the display can be prevented from lowering even in the case where a fan in the main body of the equipment blows air against the rear surface of the display device. The display device having a liquid crystal panel and a backlight illuminating the liquid crystal panel that are integrated with an upper frame that covers a periphery of the front surface of the liquid crystal panel and sides of the backlight is characterized in that a cable for supplying power to a light source provided inside the backlight is led out between a side of the backlight (side mold) and the upper frame, and a portion through which the cable is led out is covered by a sheet.

### CROSS-REFERENCE TO RELATED APPLICATION

The present application claims priority over Japanese Application JP 2010-242940 filed on Oct. 29, 2010, the contents of which are hereby incorporated into this application by reference.

### BACKGROUND OF THE INVENTION

(1) Field of the Invention

The present invention relates to a liquid crystal display device, and in particular to a liquid crystal display device where a liquid crystal panel and a backlight for illuminating the liquid crystal panel are integrated with an upper frame that covers the periphery of the front surface of the liquid crystal panel and the sides of the backlight.

(2) Description of the Related Art

Liquid crystal display devices are widely used for various types of applications, not only as monitors of personal computers and televisions, but also as display devices for medical equipment. Liquid crystal display devices have a liquid crystal panel and a backlight integrated with an upper frame that covers the liquid crystal panel and the backlight in such a manner that the upper frame is screwed and secured to the frame or certain locations in the body of the liquid crystal display device.

In liquid crystal display devices, it is easy for dust to enter into the space inside the backlight or the space between the liquid crystal panel and the backlight. In particular, a fan mounted in the main body of the equipment would allow dust to easily enter through the rear of the liquid crystal display device (the rear of the backlight), which leads to such a problem that the quality of the display is lowered.

Meanwhile, as shown in JP 2007-171877A, dust can be prevented from entering through the slight space between the liquid crystal panel and the backlight by pasting a dust preventing tape so that the periphery of the display surface of the liquid crystal panel and the sides of the backlight are covered.

However, a light source is provided inside the backlight, and it is necessary for the cable for supplying the power to the light source to be led out to the outside of the backlight. In addition, a light source using a high voltage, such as a cold cathode fluorescent lamp (CCFL), has a thick cable for connecting the light source to an external circuit substrate, and the number of cables increases in accordance with the number of fluorescent lamps. Therefore, sealing using a dust preventing tape cannot provide a sufficient measure to protect against dust.

### SUMMARY OF THE INVENTION

An object of the present invention is to solve the above-described problem and provide a liquid crystal display device where dust can be prevented from entering into the liquid crystal display device, and thus the quality of the display can be prevented from lowering even in the case where a fan in the main body of the equipment blows air against the rear surface of the liquid crystal display device.

In order to achieve the above-described object, the present inventor had diligently searched and analyzed the path through which dust enters into liquid crystal display devices, and as a result found that liquid crystal display devices having a backlight directly beneath the CCFL have a space in a portion through which the cable for the CCFL is led out, and in some cases, dust enters through this portion together with the air blown by the fan. In addition, the inventor had found that the inverter circuit is mounted with a gap vis-à-vis the lower frame using a self-spacer, taking heat radiation into consideration, and therefore in some cases, dust enters through this gap together with the air from the fan.

In order to clog these paths through which dust enters, the present invention makes the following means available.

(1) A liquid crystal display device, having a liquid crystal panel and a backlight illuminating the liquid crystal panel which are integrated with an upper frame that covers a periphery of a front surface of the liquid crystal panel and sides of the backlight, characterized in that a cable for supplying power to a light source provided inside the backlight is led out between a side of the backlight and the upper frame, and a portion through which the cable is led out is covered with a sheet.
(2) The liquid crystal display device according to the above (1), characterized in that the light source is a cold cathode fluorescent lamp, and an inverter substrate or a grounding substrate is provided on the rear surface of the backlight.
(3) The liquid crystal display device according to the above (2), characterized in that a connector to which the cable is connected is provided on the inverter substrate or the grounding substrate, and the sheet is provided so as to cover at least the portion through which the cable is led out and the connector.
(4) The liquid crystal display device according to the above (3), characterized in that the inverter substrate has a connector for an interface that is connected to an external electrical circuit, and the sheet is provided so as to cover an entirety of the inverter substrate except a plug for the connector for the interface.
(5) The liquid crystal display device according to any of the above (2) to (4), characterized in that the inverter substrate is located away from a rear surface of the backlight, and a cushion spacer is provided between the inverter substrate and the backlight.

According to the present invention, the cable for supplying power to the light source provided inside the backlight is led out between a side of the backlight and the upper frame, and the portion through which the cable is led out is covered by a sheet, and therefore dust can be prevented from entering into the liquid crystal display device through the gap (space) created in the portion through which the cable is led out. In addition, the connector to which the cable is connected is provided in the inverter substrate or the grounding substrate, and the sheet covers at least the portion through which the cable is led out and the connector in the structure, and thus it is possible to shield the path through which dust enters without fail before dust reaches the portion through which the cable is led out.

In addition, a cushion spacer is provided between the inverter substrate and the backlight, and thus the path through which dust enters through the gap between the inverter substrate and the backlight can be shielded without fail before dust reaches the portion through which the cable is led out, and as a result, it is possible for the display quality of an image to be prevented from lowering.

### BRIEF DESCRIPTION OF THE DRAWINGS

FIG. 1 is a plan diagram showing the liquid crystal display device according to the present invention as viewed from the rear (backlight side);

FIG. 2 is a cross-sectional diagram along single dot chain line A-A′ in FIG. 1;

FIG. 3 is a diagram illustrating the mode 1 of a sheet pasted to the inverter substrate;

FIG. 4 is a diagram illustrating the mode 2 of a sheet pasted to the inverter substrate; and

FIGS. 5A and 5B are diagrams illustrating the mode 3 of a sheet pasted to the inverter substrate.

### DESCRIPTION OF THE EMBODIMENTS

The liquid crystal display device according to the present invention is described below in detail.

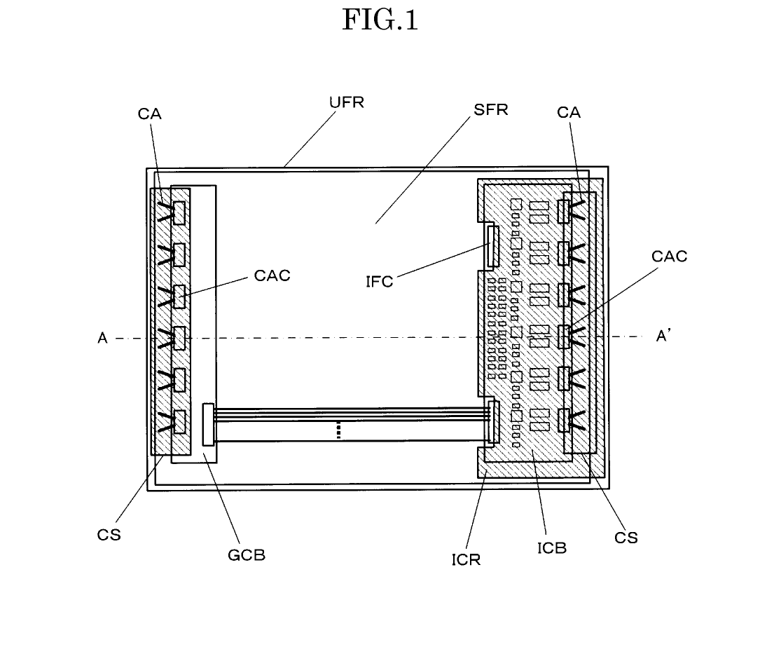

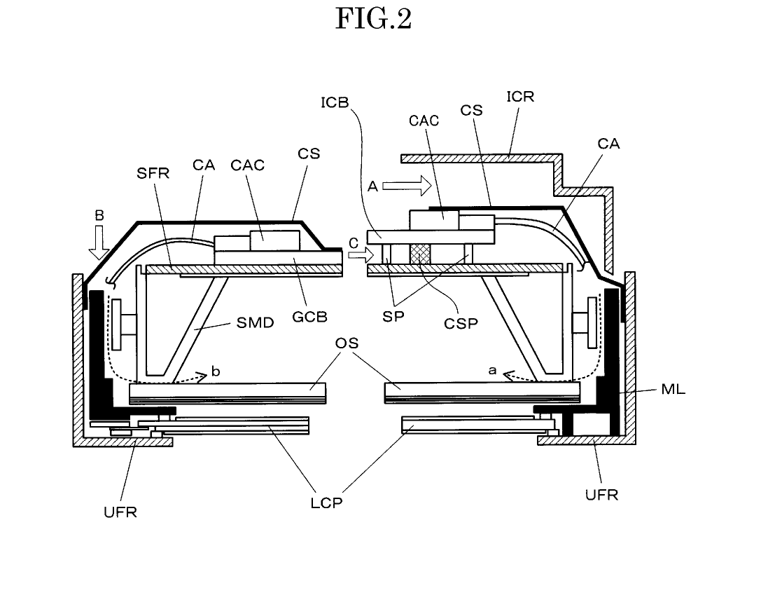

FIG. 1 is a plan diagram showing the liquid crystal display device according to the present invention as viewed from the rear (backlight side), and FIG. 2 is a schematic cross-sectional diagram along single dot chain line A-A′ in FIG. 1.

As shown in FIGS. 1 and 2, the liquid crystal display device according to the present invention is a liquid crystal display device having a liquid crystal panel LCP and a backlight illuminating the liquid crystal panel that are integrated with an upper frame UFR that covers a periphery of the front surface of the liquid crystal panel and sides of the backlight, and is characterized in that a cable CA for supplying power to a light source provided inside the backlight is led out between a side of the backlight (side mold, SMD) and the upper frame UFR, and a portion through which the cable CA is led out is covered by a sheet CS.

As shown in FIG. 2, the liquid crystal display device has the liquid crystal panel LCP and the backlight that are integrated. The backlight has a number of cold cathode fluorescent lamps (not shown), which are light sources, aligned inside the frame formed of the lower frame SFR and the side mold SMD. The light sources are not limited to cold cathode fluorescent lamps, and various types of light sources, such as external electrode fluorescent lamps and light emitting diodes, are available. In addition, the place where the light sources are provided is not limited to directly beneath the liquid crystal panel and may be in a side portion on the rear of the liquid crystal panel. In the case where cold cathode fluorescent lamps are provided directly beneath the liquid crystal panel, it is necessary for a number of cables for supplying high voltage power to be led out between the a side mold SMD of the backlight and the upper frame UFR, and thus it is more preferable for the present invention to be applied.

In the case where fluorescent lamps are used as the light sources, the fluorescent lamps are aligned in the lateral direction in FIG. 2 in locations that are a predetermined distance away from the lower frame SFR (locations away from SFR in the downward direction in FIG. 2). A reflective sheet is provided between the fluorescent lamps and the lower frame SFR, and in addition, an optical sheet OS for dispersing/conversing light radiated from the light sources so as to gain uniform light for an image is provided between the fluorescent lamps and the liquid crystal panel.

The cable CA for supplying power to the light sources is led out to the outside of the backlight from the outer side of the side mold so as to be connected to the connector CAC provided on the grounding substrate GCB secured to the rear surface of the lower frame SFR of the backlight or the connector CAC provided on the inverter substrate ICB. The inverter substrate ICB is placed away from the lower frame SFR using a self-spacer SP in order to increase the effects of releasing heat.

The liquid crystal panel LCP and the backlight are integrated in such a manner that the periphery of the liquid crystal panel LCP is sandwiched between the mold ML and the upper frame UFR, and furthermore the mold ML and the upper frame UFR are placed and secured so as to cover the backlight.

An inverter cover ICR is provided on the rear surface of the liquid crystal display device so as to cover the inverter substrate ICB.

In the case where the cable CA is led out between the side mold SMD of the backlight and the upper frame UFR, there is a gap between the side mold SMD and the upper frame UFR. In the case where the air moves in the direction of the arrows A and B, dust passes between the side mold SMD and the upper frame UFR (mold ML) and moves into the backlight between the side mold SMD and the optical sheet OS, as illustrated by the dotted arrows a and b. In addition, dust passes through the gap between the optical sheet OS and the mold ML or through the gap between the mold ML and the upper frame UFR so as to enter between the liquid crystal panel LCP and the optical sheet OS.

When the air moves as illustrated by the arrow C, dust passes between the lower frame SFR and the inverter substrate ICB, and as a result of this movement, dust enters into the backlight as in the case where the air moves as illustrated by the arrow A.

In order to solve this inconvenience, the liquid crystal display device according to the present invention has a sheet CS provided in the structure in such a manner that the portion through which the cable CA is led out is covered by the sheet CS, as shown in FIGS. 1 and 2. Furthermore, a cushion spacer is provided between the inverter substrate ICB and the lower frame UFR so that the air illustrated by the arrow C can be prevented from entering into the portion through which the cable is led out.

An electrically insulating material having excellent resistance to heat, such as PET (polyethylene terephthalate), is appropriate for use as the sheet CS. A PET sheet having a thickness of 0.1 mm or less, for example, can be used in such a manner that the shield is made to make close contact with the inverter substrate or the grounding substrate or with the upper frame UFR or the mold ML with the cover sheet being bent due to its high processability. The sheet CS can be pasted to the inverter substrate or the upper frame using a double-sided tape.

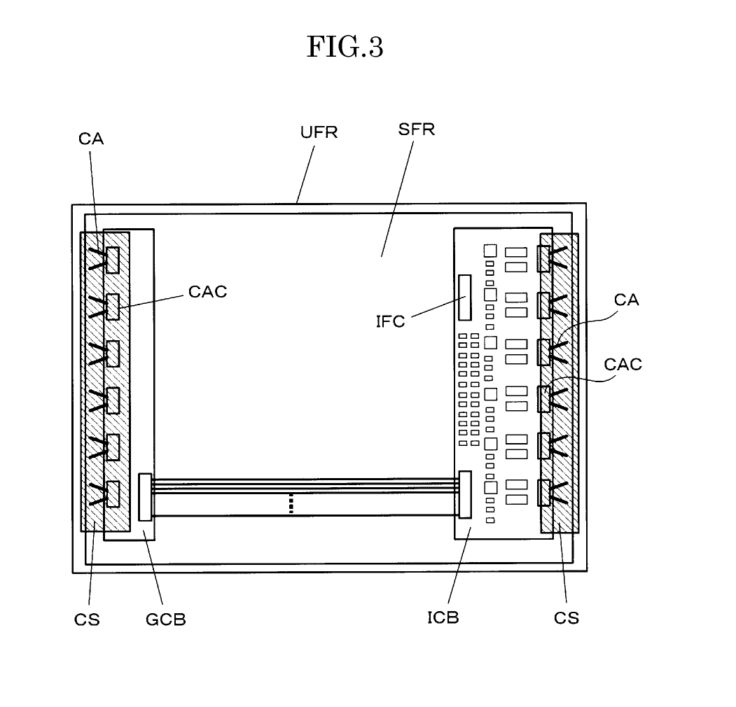

Electronic parts are provided on the inverter substrate, and therefore any of the modes 1 to 3 of a sheet pasted to the inverter substrate can be selected, as shown in FIGS. 3 to 5B, depending on the number and the arrangement of electronic parts.

In FIG. 3, the connector CAC to which the cable CA is connected is provided on the inverter substrate ICB or on the grounding substrate GCB, and the sheet CS is provided so as to cover the portion through which the cable CA is led out and the connector CAB. There are almost no parts mounted on the grounding substrate GCB side other than the connector CAC, and therefore it is possible to paste the sheet CS to the grounding substrate GCB so as to wrap the connector CAC for connecting the cable.

However, circuit parts, such as transformers, are mounted on the inverter substrate ICB with high density, and the inverter substrate ICB does not have a space to which the sheet CS is pasted, and therefore the sheet CS is pasted to the connector CAC for connecting the cable. As a result, there is a gap between the connectors through which dust enters, although it is small.

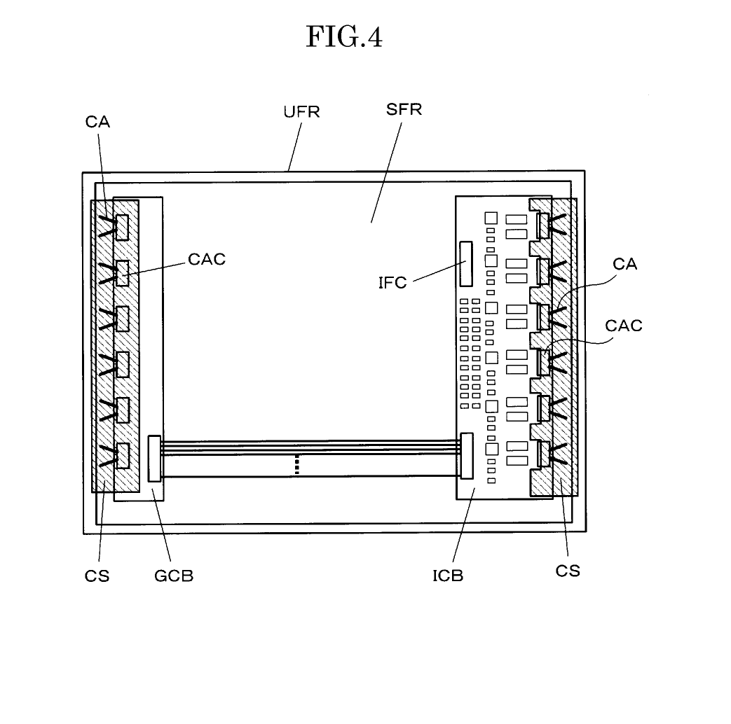

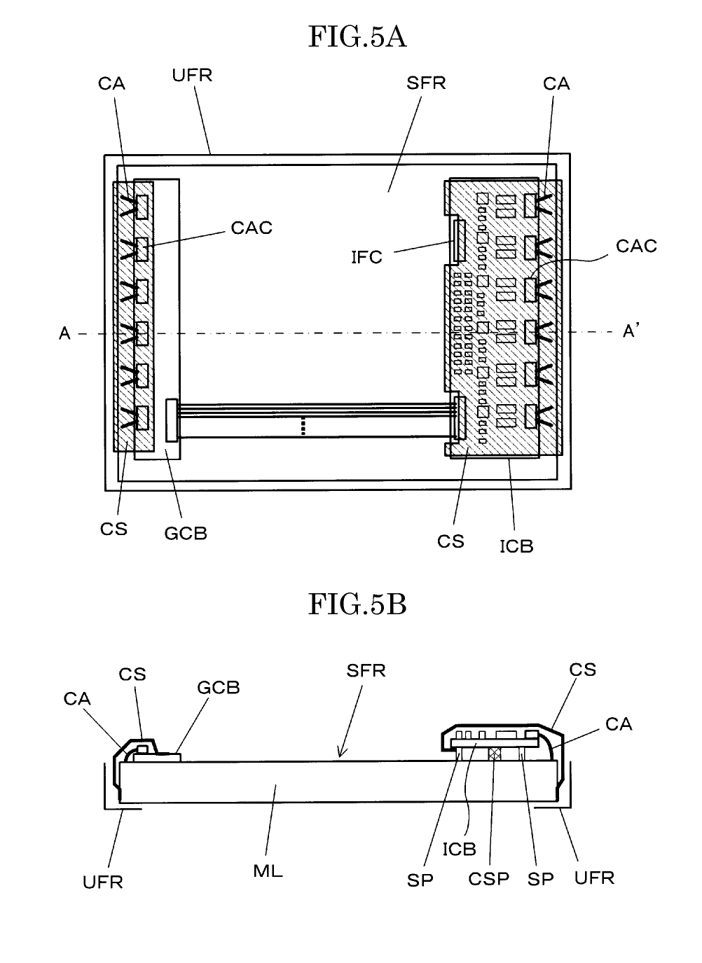

FIG. 4 is a diagram showing the mode 2 of a sheet pasted to the inverter substrate, where the sheet CS is uneven in order to clog the gap between the connectors CAC for connecting the cable. It is possible to clog the gaps between the connectors CAC through which dust enters because the protrusions on the sheet make close contact with the substrate. In the case where parts are mounted on the inverter substrate with such a high density that this mode cannot be implemented, it is possible to cover the entirety of the inverter substrate ICB with the sheet, as shown in FIG. 5. Here, the inverter substrate ICB has a connector IFC for the interface that is connected to an external electrical circuit, and therefore the sheet CS is provided so as to cover the entirety of the inverter substrate ICB except the plug for the connector IFC for the interface. FIG. 5B is a schematic cross-sectional diagram along single dot chain line A-A′ in FIG. 5A.

In the liquid crystal display device according to the present invention, as represented by CSP in FIGS. 2 and 5B, a cushion spacer is provided in order to clog the gap between the inverter substrate ICB and the lower frame UFR. The material of the cushion spacer is not particularly limited as long as it is an electrically insulating material having excellent resistance to heat, and in addition, it is a material with which the gap can be clogged due to its elasticity so as not to allow dust to pass through.

Though the structure of the present invention is described above using a liquid crystal display device as the main example, it is possible to apply the present invention to products other than liquid crystal display devices where the inside of the product and an external substrate are connected through a cable, and it is necessary to prevent dust from entering.

As described above, the present invention can provide a liquid crystal display device where dust can be prevented from entering into the liquid crystal display device and the quality of the display can be prevented from lowering even in the case where a fan in the main body of the equipment blows air against the rear surface of the liquid crystal display device.

What is claimed is:

1. A liquid crystal display device, comprising a liquid crystal panel and a backlight illuminating the liquid crystal panel which are integrated with an upper frame that covers a periphery of a front surface of the liquid crystal panel and sides of the backlight, wherein
a cable for supplying power to a light source provided inside the backlight is led out between a side of the backlight and the upper frame, and
a portion through which the cable is led out is covered with a sheet.

2. The liquid crystal display device according to claim 1, wherein the light source is a cold cathode fluorescent lamp, and an inverter substrate or a grounding substrate is provided on the rear surface of the backlight.

3. The liquid crystal display device according to claim 2, wherein a connector to which the cable is connected is provided on the inverter substrate or the grounding substrate, and the sheet is provided so as to cover at least the portion through which the cable is led out and the connector.

4. The liquid crystal display device according to claim 3, wherein the inverter substrate has a connector for an interface that is connected to an external electrical circuit, and the sheet is provided so as to cover an entirety of the inverter substrate except a plug for the connector for the interface.

5. The liquid crystal display device according to claim 2, wherein the inverter substrate is located away from a rear surface of the backlight, and a cushion spacer is provided between the inverter substrate and the backlight.

6. The liquid crystal display device according to claim 3, wherein the inverter substrate is located away from a rear surface of the backlight, and a cushion spacer is provided between the inverter substrate and the backlight.

7. The liquid crystal display device according to claim 4, wherein the inverter substrate is located away from a rear surface of the backlight, and a cushion spacer is provided between the inverter substrate and the backlight.
